(19) United States
(12) Patent Application Publication
(10) Pub. No.: US 2015/0378348 A1
(43) Pub. Date: Dec. 31, 2015

(54) INTEGRATED PLATFORM FOR 3D PRINTING ECOSYSTEM INTERFACES AND SERVICES

(71) Applicant: HCL Technologies Ltd., Noida (IN)

(72) Inventors: Akhilesh Kumar Gupta, Noida (IN); Mukta Agarwal, Noida (IN)

(21) Appl. No.: 14/728,886

(22) Filed: Jun. 2, 2015

(30) Foreign Application Priority Data
Jun. 27, 2014 (IN) 1723/DEL/2014

(51) Int. Cl. G05B 19/408; G06F 9/445

(52) U.S. Cl. CPC G05B 19/408; G06F 8/61; B33Y 30/00

(57) ABSTRACT

An integrated platform for 3D printing. This invention relates to 3D printing systems and more particularly to an integrated platform for enabling 3D printing and development of the integrated platform. The principal object of this invention is to propose a configurable 3D printing unified service platform that enables various players in a 3D printing ecosystem to interface and manage various services around 3D printing. Another object of the invention is to propose a method and system for creating a configurable 3D printing unified service platform that enables various players in a 3D printing ecosystem to interface and manage various services around 3D printing.

### CROSS-REFERENCE TO RELATED APPLICATIONS

This application claims priority to Indian application no. 1723/DEL/2014 filed on Jun. 27, 2014, the complete disclosure of which, in its entirety, is herein incorporated by reference.

### FIELD OF INVENTION

This invention relates to 3D printing systems and more particularly to an integrated platform for enabling 3D printing and development of the integrated platform.

### BACKGROUND OF INVENTION

3D printing involves getting a 3D object to be printed using a 3D model file from a 3D printer machine. In the whole process of 3D printing, there are multiple players involved such as 3D Printer manufacturers, companies providing online 3D printing services (market places, communities, social networks and so on), end consumers (individual users or companies) who want to get a 3D object printed (wherein the consumers may make a request for 3D printing using a web-based portal for selling/printing a 3D model, directly to the 3D printer, through a service provider and so on), organizations developing 3D printing support in their software (such as Microsoft, Adobe and so on), maintenance and diagnostics service providers for 3D printers, app developers enabling access to 3D printing services (such as mobile devices, tablets, phones, laptops, computers and so on), vertical OEMs (Original Equipment Manufacturers) who are developing 3D printing in a vertical manner (medical/auto/aero component manufacturers, OEM/Semi/Printer OEM/Consumer OEMs, Consumer part OEM and so on), online//Manufacturers/3D printing service providers and so on.

It becomes essential to enable the various players to interact with each other to enable effective 3D printing services. There are cloud based 3D printing services, which enables 3D printing from the cloud wherein the 3D printer is accessed by the consumer through the cloud; but this is restricted to a consumer performing 3D printing.

### OBJECT OF INVENTION

The principal object of this invention is to propose a 3D printing unified service platform that enables various players in a 3D printing ecosystem to interface and manage various services around 3D printing.

Another object of the invention is to propose a method and system for creating a 3D printing unified service platform that enables various players in a 3D printing ecosystem to interface and manage various services around 3D printing.

### STATEMENT OF INVENTION

Accordingly the invention provides a configurable platform for enabling 3D (3 Dimensional) printing, the platform comprising of a plurality of 3D printers; a user interface for enabling at least one user to upload jobs to the plurality of 3D printers; a maintenance manager to enable a maintenance organization to monitor the status of the plurality of printers; perform diagnosis on the plurality of printers; perform maintenance of the plurality of printers; and monitor status of maintenance of the plurality of printers; an API (Application Programming Interface) for enabling at least one third party to connect to the platform; and a controller for managing the jobs received from the at least one user, wherein the controller is configured for managing the jobs by validating the job for print compatibility based on a selected printer and 3D print files associated with the job; routing the job to the selected 3D printer connected to the platform, on validating the job; and enabling the user to track the job.

Also, provided herein is a system for managing a configurable 3D (3 Dimensional) printing platform, the system configured for creating the platform by generating a base platform corresponding to attributes received from a developer; modifying the base platform by the developer, if the developer wishes to modify the base components; and deploying the platform over a cloud; enabling addition of at least one component to the platform; generating base components corresponding to attributes received from the developer; modifying the base components by the developer, if the developer wishes to modify the base components; and deploying the base components to the platform over a cloud; enabling removal of at least one component from the platform; and enabling modification of at least one component from the platform.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This invention is illustrated in the accompanying drawings, through out which like reference letters indicate corresponding parts in the various figures. The embodiments herein will be better understood from the following description with reference to the drawings, in which:

FIG. 1 depicts a 3D printing unified service platform connected to a plurality of players in a 3D printing ecosystem, according to embodiments as disclosed herein;

FIG. 2 depicts a platform development engine, according to embodiments as disclosed herein;

FIG. 3 depicts a 3D printing unified service platform, according to embodiments as disclosed herein;

FIG. 4 is a flowchart illustrating the process of creating a 3D printing platform, according to embodiments as disclosed herein;

FIG. 5 is a flowchart illustrating the process of adding components to a 3D printing platform, according to embodiments as disclosed herein; and

FIGS. 6a and 6b are flowcharts illustrating the process of performing 3D printing using the 3D printing platform, according to embodiments as disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

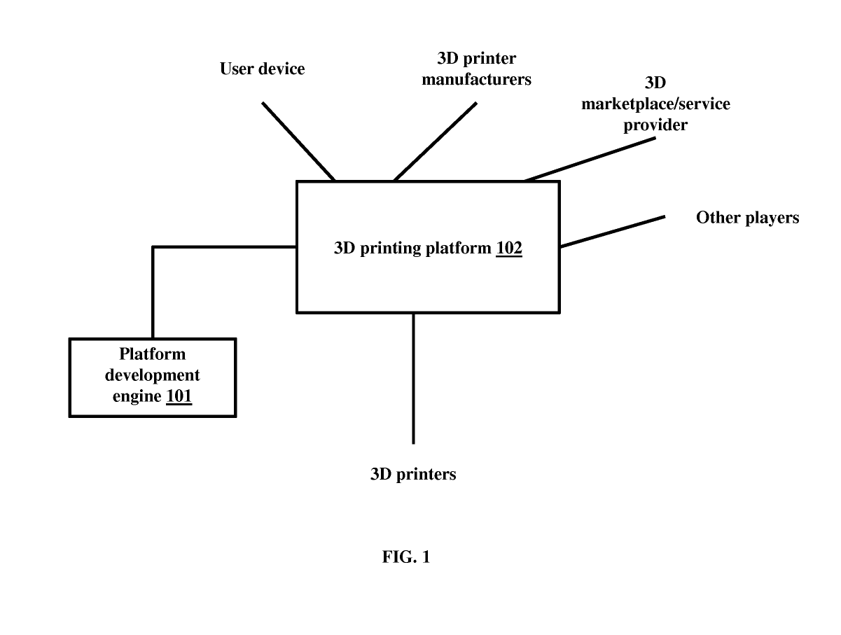

The embodiments herein propose a configurable 3D (3 Dimensional) printing unified service platform that enables various players in a 3D printing ecosystem to interface and manage various services around 3D printing and a method and system for creating a configurable 3D printing unified service platform that enables various players in a 3D printing ecosystem to interface and manage various services around 3D printing. Referring now to the drawings, and more particularly to FIGS. 1 through 6, where similar reference characters denote corresponding features consistently throughout the figures, there are shown preferred embodiments.

FIG. 1 depicts a 3D printing unified service platform connected to a plurality of players in a 3D printing ecosystem, according to embodiments as disclosed herein. The figure depicts a 3D printing platform 102 connected to at least one 3D printer. The 3D printing platform 102 may be co-located with the 3D printer. The 3D printing platform 102 may be located remotely from the 3D printer. The 3D printing platform 102 and the 3D printer may be connected using a suitable connection means such as a wired means or a wireless means. The 3D printing platform 102 may be connected to a plurality of players related to 3D printing such as at least one user device, at least one 3D printer manufacturer, at least one 3D printer servicing center, at least one 3D marketplace, at least one service provider and so on. The user device may enable a user to avail 3D printing services, such as getting an object printed by the 3D printer. The user device may also a user to monitor and control the 3D printing platform 102. The user device may be a smart phone, a tablet, a laptop, a computer or any other device capable of communicating with the 3D printer, through the 3D printing platform 102. The user device may use an app to communicate with the 3D printer, through the 3D printing platform 102. The user device may use a web portal to communicate with the 3D printer, through the 3D printing platform 102.

The 3D printer manufacturer may perform maintenance and diagnostic services on the 3D printer through the 3D printing platform 102. The 3D marketplace and the service provider provide a means to provide at least one object, modifications to the provided object, creating a 3D object in a suitable format and so on to a user. Other players such as vertical OEMs (Original Equipment Manufacturers) who are developing 3D printing in a vertical manner (medical/auto/aero component manufacturers, OEM/Semi/Printer OEM/Consumer OEMs, Consumer part OEM and so on), online//Manufacturers/3D printing service providers, online and TSP delivering add-on service and LVM service to OEM/ISV and so on may also access the 3D printing platform 102.

The platform development engine 101 enables a developer to create the 3D printing platform 102. The platform development engine 101 may modify the 3D printing platform 102 at any point in time, wherein the modification may be in terms of adding components (wherein the components enables the platform to make features/services related to 3D printing through the platform 102) to the platform 102, removing components from the platform 102 and so on. The platform development engine 101 may modify the platform 102 on receiving instructions from the developer.

The platform development engine 101 may also enable the developer to develop their own components. The platform development engine 101 may enable the developer to use the developed components on the platform 102. The platform development engine 101 may also make the developed component available to other developers, wherein the other developers may use the components on the platform 102.

The developer herein may be an authorized person, with the requisite permissions to modify the platform 102.

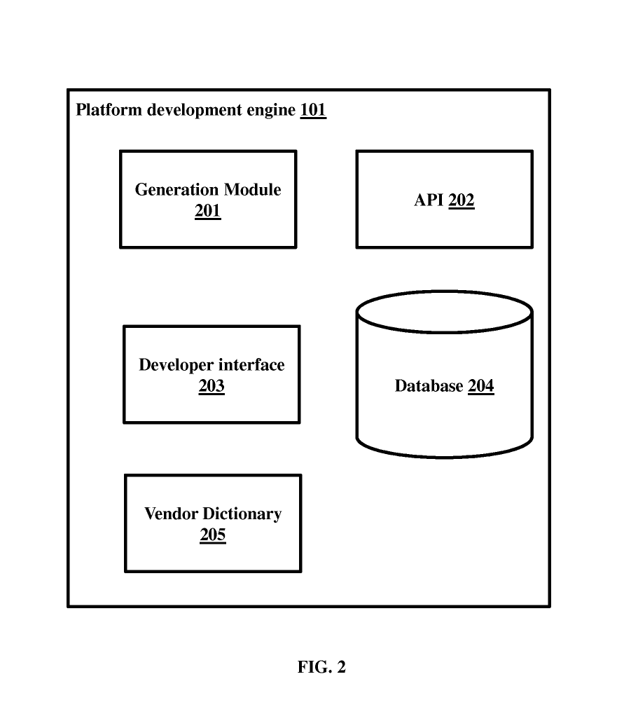

FIG. 2 depicts a platform development engine, according to embodiments as disclosed herein. The platform development engine 101 comprises of a generation module 201, an API (Application Programming Interface) 202, a developer interface 203, a database 204 and a vendor dictionary 205. The API 201 enables the platform development engine 101 to interact with the platform 102, wherein the interaction may comprise of receiving instructions from the platform 102, providing instructions to the platform 102, adding/modifying components to the platform 102 and so on. The developer interface 203 enables the developer to interface with the platform development engine 101. The developer interface 203 may be a web based interface, wherein the developer may access the interface 203 using a web browser. The developer interface 203 may be an app accessible to the developer. The database 204 may comprise of details related to the platform, components, 3D printers, developer authorization details and so on.

The vendor dictionary 205 may comprise of information related to various vendors related to 3D printers. The vendors may comprise of manufacturers, service providers, app developers and so on. The vendor dictionary 205 may comprise of information related to the capabilities of the 3D printers, the technologies of the printers, files/drivers related to the printers and so on. On the developer adding a new 3D printer to a platform 102 using the platform development engine 101, the vendor dictionary 205 may store the information related to the printer. The vendor dictionary 205 may enable the information related to the 3D printer to be used, when similar printers (printers from the same manufacturer, printers with similar capabilities and so on) are being added to the platform 102 using the platform development engine 101.

The developer interface 203 enables a developer to enter at least one defining attribute. The attributes may be related to the platform 102, if the developer wants to create the platform 102. The attributes may be related to the components, if the developer wants to add/modify components related to the platform 102. Before enabling the developer to enter the attributes, the developer interface 203 may check if the developer is authorized to access the platform development engine 101.

In the case of the developer wanting to create the platform 102, the generation module 201 generates a base software platform. The base software platform may be in the form of software code. The generation module 201 may use a suitable method for generating the code. The generation module 201 checks if the developer wants to modify the base platform. The developer may modify the base platform using the development interface 203. On the developer completing the modification of the base platform or the developer not modifying the base platform, the generation module 201 deploys the base platform as the platform 102 over the cloud, through the API 202.

In the case of the developer wanting to add/modify components to the platform 102, the generation module 201 generates the base components. The base components may be in the form of software code. The generation module 201 may use a suitable method for generating the code. The generation module 201 checks if the developer wants to modify the base components. The developer may modify the base components using the development interface 203. On the developer completing the modification of the base components or the developer not modifying the base components, the generation module 201 deploys the base components onto the platform 102 over the cloud, through the API 202.

The development interface 203 may also enable the developer to develop their own components. The developed components may be stored in the database 204. The generation module 201 may make the developed component available to other developers, wherein the other developers may use the components on the platform 102.

The platform development engine 101 may store a knowledge dictionary containing knowledge of a set of 3D printer types in the database 204.

Consider an example where the component to be added is a new 3D printer. The developer provides attributes such as OS (Operating System) platform of the computer where printer is installed (Windows, MAC, Linux and so on), whether the 3D printer is a consumer or an industrial printer; the print technology used by the 3D printer (SLA (Stereolithography), FDM (Fused Deposition Modeling) and so on), manufacturer of the 3D printer, the material used by the 3D printer for printing, size related properties of the objects that can be printed by the 3D printer, precision capabilities of the 3D printer, file formats supported by the 3D printer and so on. The generation module 201 generates the components based on the provided attributes of the 3D printer and deploys the components onto the platform 102, which enables the 3D printer to work with the platform.

Consider an example, wherein the developer wishes to add a component which will enable external users to upload their 3D print files for printing to the platform. The users may use an online portal for uploading the 3D print files. The platform development engine 101 may enable addition of this component using a standard template for providing necessary attributes about the 3D print file being uploaded for print. The details may comprise of material which may be used for printing (Plastic, Rubber, Metal and so on), colour of the printed object, size and precision of print object, acceptable file formats (stl, 3DS and so on) and so on. the platform development engine 101 may identify additional components associated with the component being added, such as the component for pricing and payment where the price for printing the given model is calculated based on certain defined criteria and then user can make the online payment for the same, component for enabling users to track their order status from the platform 102.

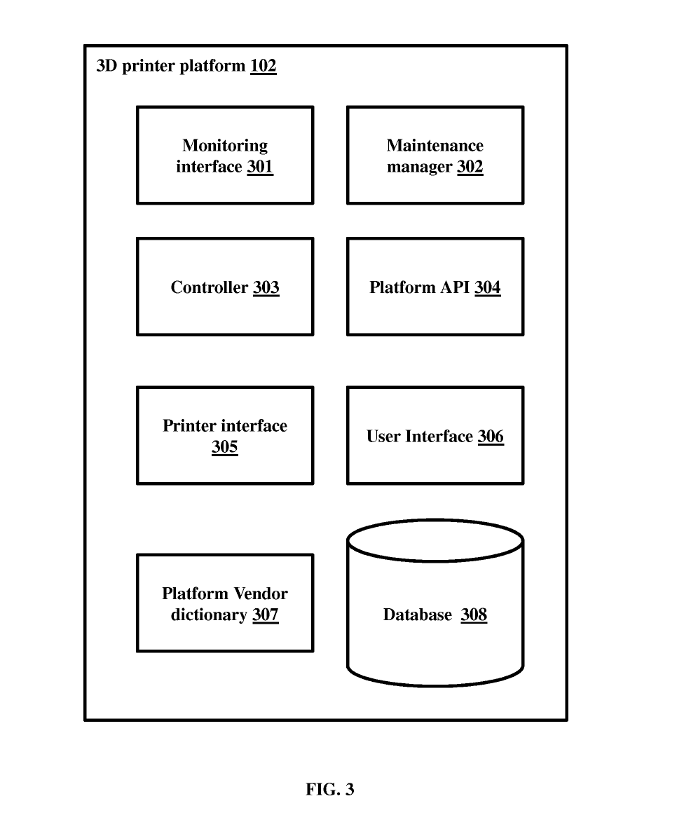

FIG. 3 depicts a 3D printing unified service platform, according to embodiments as disclosed herein. The platform 102 comprises of a monitoring interface 301, a maintenance manager 302, a controller 303, a platform API 304, a printer interface 305, a user interface 306, a platform vendor dictionary 307 and a database 308. The database 308 may comprise of authentication details for users/administrators and so on, information related to the 3D printers connected to the platform 102, information about current and previous print jobs and so on.

The interface herein (301, 305 and 306) may be web based interfaces, which may be accessed using a suitable means such as a web browser. The monitoring interface 301 enables a monitoring device to monitor the platform 102. The monitoring device may be a computer, a laptop, a mobile phone, a tablet, a console based device or any other device capable of connecting to the platform 102. The monitoring device may be a generic device, which may monitor the platform 102 as one of the tasks performed by it. The monitoring device may be a dedicated device, which monitors the platform 102 as a full time task. The monitoring interface 301 may enable an administrator to monitor the platform 102, using the monitoring device. The administrator may be an authorized person and/or entity with the requisite powers to monitor the platform 102. The monitoring interface 301 may require the administrator to authenticate himself. The monitoring interface 301 may enable the administrator to monitor the number of print jobs completed, ongoing print jobs, print jobs in the queue, issues with any of the 3D printers connected to the platform 102, printing raw materials and so on. The monitoring interface 201 may also enable the administrator to raise an alert on a specific event occurring, such as a printer developing a fault, running out of printing material and so on.

The maintenance manager 302 may enable a maintenance organization such as 3D printer manufacturers, 3D printer servicing companies and so on to monitor the status of each of the 3D printers connected with the platform 102. On detecting the fault/issue with any printer, the maintenance manager 302 enables the maintenance organization to take at least one action as defined and implemented. The maintenance manager 302 may also be notified of the fault by an indication received from the monitoring interface 301. The actions may be notifying the maintenance engineer or any other authorized person for the fault, communicating with the specific printer's manufacturer company portal automatically, blocking further print requests pertaining to that specific printer and so on.

The platform API 304 may comprise of a means for external parties to connect to the platform and enable users to avail services and/or features (such as 3D printing related marketplaces, services and so on) on the platform 102. Examples of external parties connecting to the platform 102 may be organizations connected with 3D printing technology, organizations who avail 3D printing services (such as automotive organizations, consumer organizations, automobile organizations, aerospace/aeronautical organizations and so on), organizations providing add-on services and so on.

The user interface 306 may enable a user to upload 3D print jobs to the platform 102. The user interface 306 may enable the user to select the 3D printer to which the job is to be sent. The user interface 306 may enable the user to track their print jobs, such as the printer to which the job has been sent, the queue status and so on. The user interface 306 may enable the user to track deliveries of his printed 3D printing job, such as courier details, tracking number, expected delivery date and so on.

On receiving a print job, the controller 303 may check if the user is authorized to avail 3D printing services. If the user has specified a 3D printer, the controller 303 may also check if the user is authorized to access the 3D printer. The controller 303 may validate 3D model files (which are a part of the 3D print job) based on the selected printer. The controller 303 may use pre-existing criteria for validating the 3D model file for print compatibility. The controller 303 may leverage existing software/algorithms to enable the validation task. If the controller 303 is unable to validate the 3D model file for the selected printer or the user is not authorized to access the printer, the controller 303 may provide the user with an error message. On receiving the error message, the user may select another printer or modify the 3D print files, so that the 3D print files may be validated for the new selected printer.

If the user has not selected a 3D printer, the controller 303 may select a printer from a list of available printers, wherein the selected printer may be the printer with the shortest queue. The selected printer may be a local printer or an online printing service. The controller 303 may validate 3D model files (which are a part of the 3D print job) based on the selected printer. The controller 303 may use pre-existing criteria for validating the 3D model file for print compatibility. The controller 303 may leverage existing software/algorithms to enable the validation task. If the controller 303 is unable to validate the 3D model file for the selected printer, the controller 303 may select another printer.

On sending the print job to the selected and validated printer through the printer interface 305, the controller 303 may update the user of the status of the print job and so on, using the user interface 306.

The controller 303 may maintain a log in a suitable location such as the database 308, wherein the log may comprise of user logs, IP (Internet Protocol) address logs, piracy audit trails, printer diagnostics and troubleshooting logs and so on.

The platform 102 may comprise of a payment portal, wherein a user may make a payment for the 3D printing services availed by the user.

On receiving information about a component to be added from the platform development engine 101, the controller 303 may deploy the component and make the necessary changes to the platform 102, as required by the component.

The platform vendor dictionary 307 may comprise of information related to various vendors related to 3D printers. The vendors may comprise of manufacturers, service providers, app developers and so on. The platform vendor dictionary 307 may comprise of information related to the capabilities of the 3D printers, the technologies of the printers, files/drivers related to the printers and so on. On a new 3D printer being added to a platform 102, the platform vendor dictionary 307 may store the information related to the printer. The platform vendor dictionary 307 may enable the information related to the 3D printer to be used, when similar printers (printers from the same manufacturer, printers with similar capabilities and so on) are being added to the platform 102.

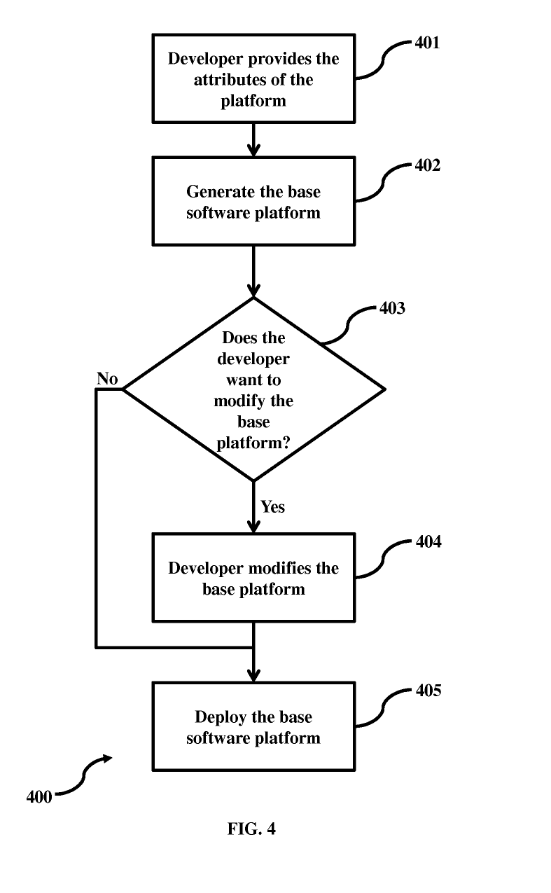

FIG. 4 is a flowchart illustrating the process of creating a 3D printing platform, according to embodiments as disclosed herein. In the case of the developer wanting to create the platform 102, the developer provides (401) the attributes of the platform 102 to the platform development engine 101. On receiving the attributes of the platform 102, the platform development engine 101 generates (402) the base software platform. The platform development engine 101 checks (403) if the developer wants to modify the base platform. If the developer wants to modify the base platform, the developer modifies (404) the base platform. On the developer completing the modification of the base platform or the developer not modifying the base platform, the platform development engine 101 deploys (405) the base platform over the cloud. The various actions in method 400 may be performed in the order presented, in a different order or simultaneously. Further, in some embodiments, some actions listed in FIG. 4 may be omitted.

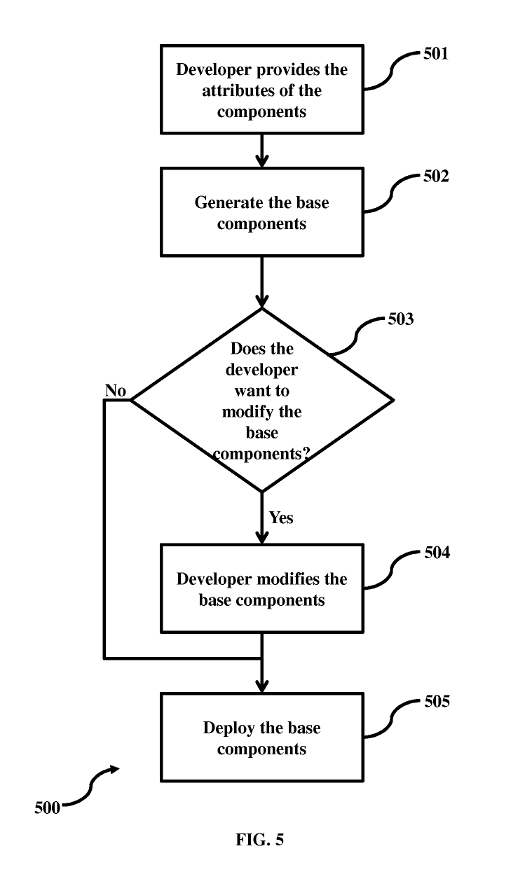

FIG. 5 is a flowchart illustrating the process of adding components to a 3D printing platform, according to embodiments as disclosed herein. In the case of the developer wanting to add components to the platform 102, the developer provides (501) the attributes of the components to the platform development engine 101. On receiving the attributes of the components, the platform development engine 101 generates (502) the base components. The platform development engine 101 checks (503) if the developer wants to modify the base components. If the developer wants to modify the base components, the developer modifies (504) the base components. On the developer completing the modification of the base components or the developer not modifying the base components, the platform development engine 101 deploys (505) the base components onto the platform 102 over the cloud. The various actions in method 500 may be performed in the order presented, in a different order or simultaneously. Further, in some embodiments, some actions listed in FIG. 5 may be omitted.

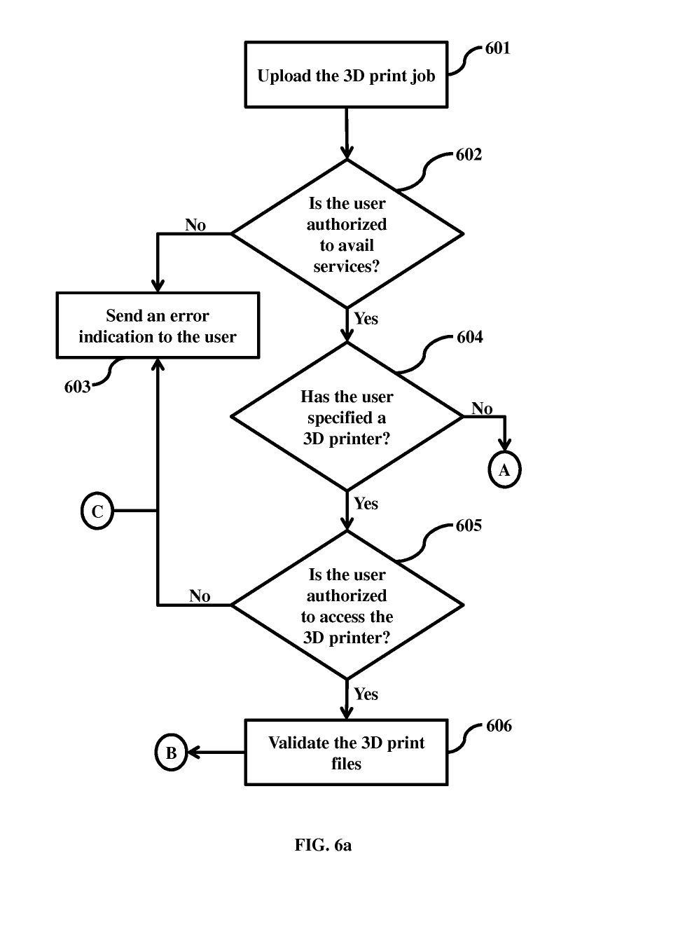

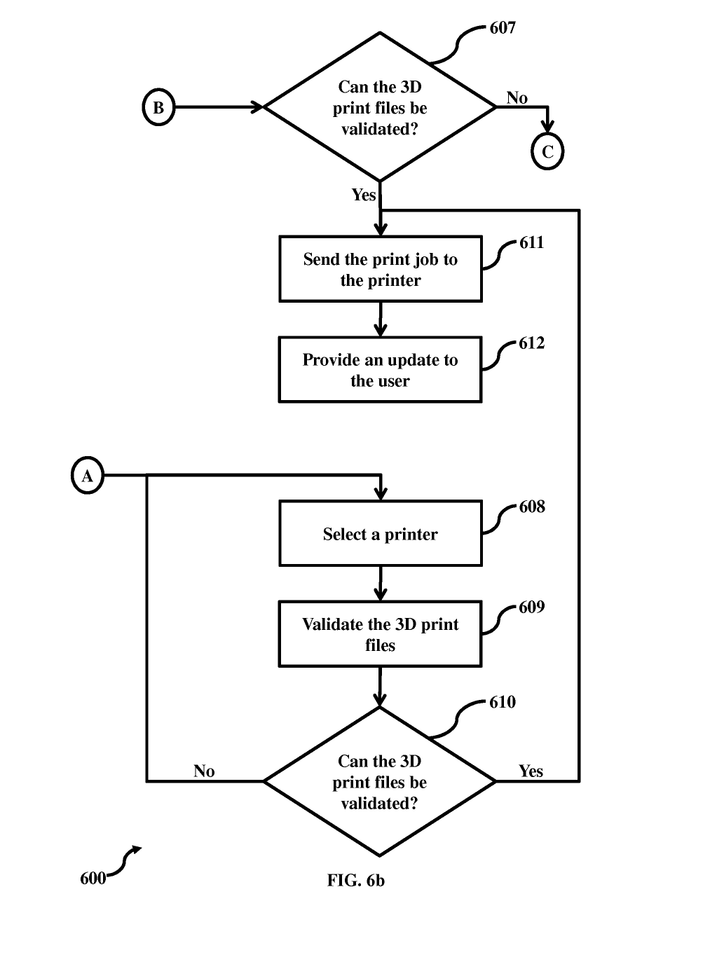

FIGS. 6a and 6b are flowcharts illustrating the process of performing 3D printing using the 3D printing platform, according to embodiments as disclosed herein. The user uploads (601) a 3D print job to the platform 102. On receiving a print job, the platform 102 checks (602) if the user is authorized to avail 3D printing services. If the user is not authorized to avail the 3D printing services, the platform 102 sends (603) an error indication to the user. The platform 102 may prompt the user to enter his authorization details again, if the user wishes to do so. If the user is authorized to avail 3D printing services through the platform 102, the platform 102 checks (604) if the user has specified a 3D printer. If the user has specified a 3D printer, the platform 102 checks (605) if the user is authorized to access the 3D printer. If the user is not authorized, the platform 102 sends (603) an error indication to the user. If the user is authorized, the platform 102 validates (606) the 3D model files based on the selected printer. If the platform 102 is not able to validate (607) the 3D model files, the platform 102 sends (603) an error indication to the user. If the platform 102 is able to validate (607) the 3D model files, the platform 102 sends (611) the 3D print job to the selected printer and provides (612) an update to the user. If the user has not specified a 3D printer, the platform 102 selects (608) a printer from a list of available printers. The platform 102 validates (609) the 3D model files based on the selected printer. If the platform 102 is not able to validate (610) the 3D model files, the platform 102 selects (608) another printer. If the platform 102 is able to validate (610) the 3D model files, the platform 102 sends (611) the 3D print job to the selected printer and provides (612) an update to the user. The various actions in method 600 may be performed in the order presented, in a different order or simultaneously. Further, in some embodiments, some actions listed in FIGS. 6a and 6b may be omitted.

Embodiments herein disclose a 3D printing unified service platform that enables various players in the 3D printing ecosystem to interface and manage various services around 3D printing. In addition embodiments herein also provide a means for automatically creating the platform using an integrated platform development engine. Embodiments disclosed herein will reduce development time via ‘write less code’ and simplifying the development work of creating the 3D printing platform.

Embodiments disclosed herein enables support on remote maintenance and diagnostics on local stack of printers, provides easy interface for easy integration of new 3D Printer through APIs and provides configuration, remote diagnostics and preventive maintenance.

Embodiments disclose an open Platform/framework which is extensible to support new printers and new service components as required, which may be developed like a platform kit enabling users to build their own apps for reporting & operations.

Embodiments disclosed herein enables creation of a flexible platform as required by an enterprise with the enterprise able to add relevant customization on services as required by the enterprise.

Embodiments disclosed herein enables extendibility of plugging-in new services/service components as required at a later point anytime.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A configurable platform for enabling 3D (3 Dimensional) printing, the platform comprising of:
a plurality of 3D printers;
a user interface for enabling at least one user to upload jobs to the plurality of 3D printers;
a maintenance manager to enable a maintenance organization to:
monitor the status of the plurality of printers;
perform diagnosis on the plurality of printers;
perform maintenance of the plurality of printers; and
monitor status of maintenance of the plurality of printers;
an API (Application Programming Interface) for enabling at least one third party to connect to the platform; and
a controller for managing the jobs received from the at least one user, wherein the controller is configured for managing the jobs by:
validating the job for print compatibility based on a selected printer and 3D print files associated with the job;
routing the job to the selected 3D printer connected to the platform, on validating the job; and
enabling the user to track the job.

2. The platform, as claimed in claim 1, wherein a platform development engine is configured for creating the platform.

3. The platform, as claimed in claim 2, wherein the platform development engine is configured for creating the platform by:
generating a base platform corresponding to attributes received from a developer;
modifying the base platform by the developer, if the developer wishes to modify the base components; and
deploying the platform over a cloud.

4. The platform, as claimed in claim 1, wherein the platform is configurable by the platform development engine, wherein the platform development engine is configured for:
enabling addition of at least one component to the platform;
enabling removal of at least one component from the platform; and
enabling modification of at least one component from the platform.

5. The platform, as claimed in claim 4, wherein the platform development engine is configured for enabling addition of at least one component to the platform by:
generating base components corresponding to attributes received from the developer;
modifying the base components by the developer, if the developer wishes to modify the base components; and
deploying the base components to the platform over a cloud.

6. The platform, as claimed in claim 1, wherein the platform further comprises of a vendor dictionary.

7. The platform, as claimed in claim 1, wherein the platform further comprises of a payment portal.

8. The platform, as claimed in claim 1, wherein the controller is configured for checking if the user is authorized to avail 3D printing services, before validating the job.

9. The platform, as claimed in claim 1, wherein the controller is configured for selecting a 3D printer from the plurality of printers connected to the platform, if the user has not selected a 3D printer, wherein the controller is configured to select the printer based on type of job and capabilities of the 3D printer.

10. The platform, as claimed in claim 1, wherein the controller is further configured for maintaining a user log.

11. A system for managing a configurable 3D (3 Dimensional) printing platform, the system configured for:
creating the platform by:
generating a base platform corresponding to attributes received from a developer;
modifying the base platform by the developer, if the developer wishes to modify the base components; and
deploying the platform over a cloud;
enabling addition of at least one component to the platform;
generating base components corresponding to attributes received from the developer;
modifying the base components by the developer, if the developer wishes to modify the base components;
deploying the base components to the platform over a cloud;
enabling removal of at least one component from the platform; and
enabling modification of at least one component from the platform.

12. The system, as claimed in claim 11, wherein the system further comprises of a vendor dictionary.
